(19) United States
(12) Patent Application Publication
(10) Pub. No.: US 2009/0307629 A1
(43) Pub. Date: Dec. 10, 2009

(54) CONTENT SEARCH DEVICE, CONTENT SEARCH SYSTEM, CONTENT SEARCH SYSTEM SERVER DEVICE, CONTENT SEARCH METHOD, COMPUTER PROGRAM, AND CONTENT OUTPUT DEVICE HAVING SEARCH FUNCTION

(76) Inventors: Naoaki Horiuchi, Tsurugashima-shi (JP); Hiroshi Toriumi, Tokyo (JP); Akio Fukushima, Tokyo (JP); Fumiko Kikuchi, Tokyo (JP)

Correspondence Address: YOUNG & THOMPSON, 209 Madison Street, Suite 500, ALEXANDRIA, VA, 22314, US

(21) Appl. No.: 12/096,127

(22) PCT Filed: Dec. 5, 2006
(86) PCT No.: PCT/JP2006/324273

§ 371 Date: Jul. 23, 2008

(30) Foreign Application Priority Data
Dec. 5, 2005 (JP) 2005-351045

(51) Int. Cl. G06F 17/30; G06F 3/048

(52) U.S. Cl. 715/810; 707/3; 707/E17.014

(57) ABSTRACT

In an on-vehicle audio device (10), a CPU (111) executes a music composition search process. In the music composition search process, when an icon is selected from an icon selection region (220) on a display screen (210) and arranged in an icon setting region (230), the icon is set as an icon represent ting a search condition. Here, a music composition having a music composition characteristic amount corresponding to the attribute of the icon is searched from a music composition DB (151). On the other hand, when a plurality of icons are arranged while being superposed in the icon setting region (230), a synthesized icon corresponding to the superposition is displayed in the icon setting region (230) according to a preset correspondence, so as to search a music composition having the music composition characteristic amount corresponding to the attribute of the synthesized icon.

### TECHNICAL FIELD

The present invention relates to a content search apparatus for searching for various contents such as music, a content search system, a server apparatus for the content search system, a content search method, a computer program, and a content output apparatus with such a search function for searching for and outputting the contents.

### BACKGROUND ART

As this type of technical field, using icons has been suggested (e.g. refer to a patent document 1 or the like). According to an information search method disclosed in the patent document 1 (hereinafter referred to as a “conventional technology”), if a desired icon is selected from icons displayed on a screen on a user terminal side, a search server searches for a related content on the basis of information about the selected icon, and presents information about the searched content on an icon answer screen on the user terminal side, so that a user can set a search condition by instinct even if the user does not correctly understand a search target.

Patent document 1: Japanese Patent Application Laid Open NO. 2003-271630

### DISCLOSURE OF INVENTION

### Subject to be Solved by the Invention

If a large amount of contents is searched for the content that matches the user's feeling or emotion, there will be an enormous number of icons for specifying the search condition. It is complicate for the user to select the icon that matches own feeling or emotion as the search condition from the enormous number of icons, resulting in a difficulty in reducing a load required for the user to search for the content. On the other hand, if there are fewer icons that are set, it can be simpler to select the icon itself; however, too many contents are associated with one icon and the user has to search for the content that truly matches the own feeling or emotion from the search result, so it is extremely inefficient. That is, the conventional technology has such a technical problem that the user can hardly search for the content that matches the own feeling or emotion, efficiently and effectively.

It is therefore an object of the present invention to provide a content search apparatus, a content search system, a server apparatus for the content search system, a content search method, a computer program, and a contents output apparatus with a search function, which can search for the content that matches the user's feeling or emotion, efficiently and effectively.

### Means for Solving the Subject

### <Content Search Apparatus>

The above object of the present invention can be achieved by a content search apparatus for searching for predetermined types of contents on a display screen provided for a displaying device, the content search apparatus provided with: a display controlling device for controlling the displaying device to display at least two of a plurality of basic icons, each of which represents an attribute of the content, as operation target icons on the display screen; a first searching device for searching for a combined icon from the plurality of basic icons on the basis of a correspondence relationship set in advance if an input is given indicating that at least two of the operation target icons are to be combined, the combined icon being defined as a combination of the at least two operation target icons to be combined; and a second searching device for searching for the content corresponding to the searched combined icon from the plurality of contents to which at least one value for defying the attribute is given in advance.

The “predetermined types of contents” in the present invention conceptually include software of a type that affects a user's audio-visual sense, feeling, and emotion, and they indicate various music songs which belong to various music genres, such as Rock, Pops, Enka or Japanese ballad, Jazz, or Classical music, and various video images which belong to various genres, such as a drama, movie, animation, documentary, or variety, or the like. Incidentally, those are merely an example, and what can be searched for by the content search apparatus of the present invention is in the scope of the contents of the present invention.

The “displaying device” of the present invention indicates various display apparatuses or the like, such as a plasma display apparatus, a liquid crystal apparatus, a liquid crystal projector apparatus, and a CRT (Cathode Ray Tube) display apparatus. There is no limitation in the size, shape, and setting aspect of the displaying device, and they may be substantially fixed at home, a company, a hospital, or various facilities or the like. Alternatively, it may have portability by installing it on a watch, a mobile phone, a PDA (Personal Digital Assistance) or the like. Alternatively, it may be installed as one portion of on-vehicle audio equipment, on-vehicle video equipment, a car navigation system, or the like.

According to the content search apparatus of the present invention, upon the operation thereof, the displaying device is controlled by the display controlling device to display at least two of the plurality of basic icons on the display screen as the operation target icons.

The “icon” of the present invention conceptually includes visual information in which various operations, such as selection and displacement, can be performed on the display screen provided for the displaying device. In particular, on the content search apparatus of the present invention, the icon is set as what represents the attribute of the content, which is a condition for searching for the content. The plurality of basic icons are prepared in advance on the content search apparatus of the present invention.

Here, the “attribute of the content” indicates the feature of the content, qualitatively or specifically. For example, it may be a qualitative feature, such as “happy”, “sad”, “cheerful”, “calm”, “with a tempo”, or “slow”, or a specific feature that matches the content, such as “male”, “female”, “wedding ceremony”, “summer”, “alcohol”, “drive”, “beach”, or “party”.

The operation target icon indicates the icon displayed on the display screen of the displaying device, out of the basic icons. That is, the operation target icon is the basic icon which is literally a target for the selection and displacement operations by the user. The displaying control device controls the displaying device to display at least two operation target icons at least in the various operations by the user. Incidentally, all the basic icons may be hidden on the display screen, if the content search is unnecessary or in similar cases. That is, the display controlling device may perform the control such that the operation target icons are displayed on the display screen if an appropriate operation is performed by the user or the like.

Here, the control performed by the display controlling device is not limited as long as at least two operation target icons are eventually displayed. For example, it may be the control to select the plurality of basic icons, completely randomly or in accordance with some algorithm, from among the basic icons stored in an appropriate memory device in advance and to display the selected icons on the display screen. Alternatively, it may be the control to obtain the data for displaying the operation target icons from an external apparatus or system or the like and to simply display the plurality of operation target icons on the displaying device on the basis of the obtained data. Alternatively, the basic icon that is considered to have high frequency of the user's operation may be selected as a result of reflection or estimation of the user's preference.

On the other hand, the first searching device searches for the combined icon, which is defined as a combination of at least two operation target icons, from the aforementioned basic icons, on the basis of the correspondence relationship set in advance, if the input is given indicating that the at least two of the operation target icons displayed on the display screen are to be combined.

Here, the “input” indicates a selection operation, an instruction operation, a displacement operation, or the like, performed by the user through various input equipment, such as a touch panel apparatus, an operation dial, an operation lever, a scroll button, or various pointing device, such as a keyboard and a mouse. Alternatively, the input in the present invention is not necessarily limited to these artificial operations, but may be a command or the like forcibly provided from control equipment and a controller or the like when e.g. some condition is satisfied.

The input indicating that the plurality of operation target icons are to be combined is set as something to perform such combination in advance, but its aspect is not limited to. For example, it may be various operations of disposing the operation target icons to be combined in a predetermined positional relationship, or operations of selecting each of the operation target icons to be combined and of issuing a predetermined combination command or the like. The input may be determined in such an aspect that it is easy to intuitively recognize that the input is an operation for mutually combining the operation target icons, on an experimental, experiential, or simulation basis in advance.

The attributes of the contents represented by respective plurality of basic icons are, of course, independent of each other; however, some attribute corresponds to a combination of the attributes represented by the respective plurality of basic icons. For example, the basic icon representing an attribute of “love song” itself can be realized as the search condition; however, the love song is basically related to love between men (or male) and women (or female), and it can be considered that the love song is the attribute obtained by combining an attribute of “male” and an attribute of “female”. For example, in this case, the first searching device searches for the basic icon representing the attribute of “love song” if an input is given indicating that the operation target icon representing the attribute of “male” and the operation target icon representing the attribute of “female” are to be combined. Basically the correspondence relationship between the basic icons may be set in an arbitrary way; however, it is preferably set to perform the user's intuitive operation to some extent, as compared to the case that the setting is performed without considering the attribute represented by each icon. Of course, it may be set not to depart from the user's average feeling or to preferably reflect the user's feeling or emotion, on an experimental, experiential, or simulation basis in advance.

The second searching device searches for the content corresponding to the searched combined icon from the plurality of contents. Here, at least one of the values for defying various attributes represented by the basic icons is given to each of the plurality of contents. The values for defining such attributes may be different from each other in the aspects thereof, depending on their attributes. For example, in case of the attribute that belongs to a qualitative group, it may be a value obtained by standardizing or quantifying the qualitative attribute.

The standardized or quantified value may represent the degree of various items that indicate the qualitative features of the contents, with a plurality of levels (e.g. ten levels or the like). For example, for the item of “happy”, the value may be provided as “1” or “10” or the like. In this case, a criterion for which numerical range of standardized or quantified value corresponds to the attribute represented by the basic icon, is preferably provided in the condition that reliability is ensured at least to the extent that a sense of discomfort is not given to the user's feeling or emotion, on an experimental, experiential, or simulation basis in advance. For example, in case of the degree of “happy” described above, the criterion may be provided such that the attribute of the basic icon is “happy” when the degree of “happy” is greater than or equal to “8”.

Moreover, the value for defining the specific attribute (e.g. a love song, wedding ceremony, drive, or the like) may be a flag which indicates whether or not to correspond to the specific attribute. The value for defining the attribute may be set in advance on the side of a provider (a content maker or content distributer or the like) which provides the contents, or the value may be adapted to be set, modified, or updated, as occasion demands, by the user on the basis of the user's feeling or emotion.

Moreover, the specific attribute may be defined by the value for defining the qualitative attribute. For example, the content corresponding to an attribute of “drive” may be a content in which a numerical value indicating the qualitative feature, such as “happy” and “tempo”, is greater than or equal to a predetermined value, in addition to the content with the flag placed in the item of “drive”, as described above. On the other hand, not only the specific attribute but also the qualitative attribute may be all expressed in a binary concept, such as the flag. That is, the content may be provided with information, such as the flag, which indicates whether or not to correspond to the attribute, with regard to all the attributes that can be given to the basic icons.

Incidentally, the first searching device and the second searching device may have the same hardware structure, or may have hardware structures which are at least partially shared. Alternatively, the first and second searching devices may have hardware structures which are completely independent of each other.

As described above, according to the content search apparatus of the present invention, even the basic icon that is not displayed as the operation target icon on the display screen can be specified as the search condition by mutually combining the plurality of operation target icons displayed on the display screen. For example, the basic icon representing the attribute of love song, as a result of combining the operation target icons which represent the attributes of male and female (i.e. the combined icon), can be specified as the search condition even if the basic icon representing the attribute of love song is not displayed on the display screen as the operation target icon.

As described above, on the content search apparatus of the present invention, it is unnecessary to display all the huge number of basic icons prepared in advance on the display screen, so that it is unnecessary for the user to search for the basic icon representing the desired attribute from the huge number of basic icons. On the other hand, each of the basic icons displayed on the display screen (i.e. the operation target icons) can represent not only the attribute represented by itself but also a new attribute by combining with each other, which solves the concern that the search result misses the point or falls far short of expectations because of the lack of the search condition. That is, it is possible to realize the search for the content that matches the user's feeling or emotion, efficiently and effectively.

In one aspect of the content search apparatus of the present invention, the display controlling device further controls the displaying device to display the searched combined icon on the display screen.

According to this aspect, if there is the combined icon, the searched combined icon is displayed on the display screen by the display controlling device, which visually assists the search operation by the user, so that it is preferable. Incidentally, at this time, the searched basic icon may be already displayed or may be not displayed on the display screen as the operation target icon. If the searched basic icon is already displayed as the operation target icon, it may be enhancement-displayed such that it can be judged to be the combined icon.

In another aspect of the content search apparatus of the present invention, it is further provided with a content information generating device for generating content information corresponding to the searched content, the display controlling device further controlling the displaying device to display the content information on the display screen.

According to this aspect, the content information is generated and is displayed on the display screen by the display controlling device, which allows the user to visually recognize the searched content, so that it is preferable.

Incidentally, the content information conceptually includes information having at least some relationship with the searched content. For example, it indicates the title of the content (a song title, movie title, or the like), artist name, director name, performer name, various supplementary information about the content, and the like. Those may be displayed in a format, such as a list, including the content desired by the user as the search result.

Incidentally, in this aspect, the content information generating device may generate a list of the searched content as at least one portion of the content information.

In this case, the list of the content(s) is generated as at least one portion of the content information and is displayed on the display screen, which makes it easy for the user to understand the search result of the desired content, so that it is preferable

In another aspect of the content search apparatus of the present invention, the first searching device searches for the combined icon if such an operation is performed that the at least two operation target icons are disposed with them mutually overlapping in a predetermined area on the display screen, as at least one portion of the input indicating that the at least two are to be combined.

According to this aspect, the first searching device searches for the combined icon if at least two of the operation target icons are disposed with them mutually overlapping in the predetermined area on the display screen. The operation of mutually overlapping the operation target icons easily gives an image of combining the icons, which allows the user's intuitive operation, so that it is preferable. Incidentally, the predetermined area on the display screen may be an arbitrary area as long as it is an area on the display screen, and it may be the entire area of the display screen in an extreme case. Alternatively, if an operation target icon display area, which is to display the operation target icon, and a working area, which is to perform the combination operation or the operation of simply selecting the operation target icon without the combination, are set in advance, the predetermined area may be the working area.

In another aspect of the content search apparatus of the present invention, the display controlling device further controls the displaying device to newly display the searched combined icon on the display screen as one portion of the operation target icons, in response to an input indicating that the searched combined icon is to be added to the operation target icons.

According to this aspect, the searched combined icon is newly displayed on the display screen as the operation target icon, which can improve the user's usability in accordance with the course of using the content search apparatus.

In another aspect of the content search apparatus of the present invention, it is further provided with a third searching device for searching for the basic icon corresponding to specified one content from the plurality of basic icons on the basis of the value for defying the attribute given to the specified one content if an input is given indicating that the one content is to be specified from the plurality of contents, the display controlling device controlling the displaying device to display the basic icon corresponding to the specified one content, on the display screen.

According to this aspect, it is not that the operation target icon is used as the search condition to search for the content but that the content is used as the search condition for reverse search for the basic icon (the operation target icon if it is displayed on the display screen). The value for defining the attribute has been given to the content, as described above, so that the reverse search is possible.

By the reverse search of the basic icon, it is possible to learn, as occasion demands, about “what types of basic icons are prepared?”, “what basic icon is to be the search target in order to obtain a content that belongs to the same category as that of this content”, or the like. It is also possible to provide feedback for the search for the content by the operation target icon, which is an original purpose of using the content search apparatus.

Of course, as a result of the reverse search, the basic icon that is considered to have high frequency of use may be added by the user to the operation target icons, as occasion demands, to thereby customize the operation target icons.

Incidentally, in this aspect, it may be further provided with a fourth searching device for searching for a plurality of basic icons that constitute the basic icon corresponding to the specified one content from the plurality of basic icons if the basic icon corresponding to the specified one content is one combined icon, the display controlling device controlling the displaying device to display the plurality of basic icons that constitute the basic icon corresponding to the specified one content, on the display screen.

The basic icon obtained as a result of the reverse search described above is possibly the aforementioned combined icon. In this case, it means that there are the basic icons that constitute the relevant basic icon. Thus, as described above, they are displayed as the search result, to thereby dramatically improve a learning effect.

In another aspect of the content search apparatus of the present invention it is further provided with: an icon generating device for newly generating an icon by combining a plurality of parts, selected from a plurality of parts set in advance, on the display screen; and an icon registering device for newly registering the generated icon as the basic icon by giving the attribute to the generated icon.

According to this aspect, the basic icon can be increased, so that it is possible to specify the search condition in more details. Incidentally, the attribute given to the generated icon may be an attribute that has been already set for the basic icon, or may be an attribute having the new content.

Incidentally, “register” means, for example, to newly store something; however, in the content search apparatus of the present invention, the basic icon, more specifically the information (or data) about the basic icon, may be stored in the content search apparatus or may be stored on a predetermined recording medium externally connected thereto.

In another aspect of the content search apparatus of the present invention, it is further provided with an inputting device capable of performing predetermined types of inputs including the input indicating that the at least two operation target icons are to be combined.

According to this aspect, it is provided with the inputting device which can adopt the various forms of input equipment, such as a touch panel apparatus, an operation dial, an operation lever, a scroll button, or various pointing device, such as a keyboard and a mouse. Thus, it is possible to preferably perform various operations of selection, displacement, and determination related to the content search apparatus, or an input indicating that the aforementioned combined icon is to be added, an input indicating that one content is to be specified from the plurality of contents, or the like.

In another aspect of the content search apparatus of the present invention, it is further provided with a memory device for storing the plurality of contents.

According to this aspect, it is possible to search for the content, efficiently and effectively, by storing the contents in the memory device having various recording media, such as a hard disk, a DVD, a CD, or a BD. In this case, moreover, the user can easily add the content, as occasion demands, and in particular, the user's shooting video or recorded audio or the like can be also stored as one portion of the contents, so that it is preferable.

<Content Output Apparatus with Search Function>

The above object of the present invention can be also achieved by a content output apparatus with a search function, provided with: the content search apparatus described above (including its various aspects); and an outputting device for outputting the searched content.

According to the content output apparatus with the search function of the present invention, the content that is searched for to match the user's feeling or emotion is further outputted to the user, so that it is possible to provide a high degree of satisfaction for the user.

Incidentally, the form of the outputting device varies depending on the types and content of the contents or the like, and it may be changed depending thereon as occasion demands. For example, the outputting device may be a reproducing apparatus for a hard disk and a DVD or the like, or may have various types of audio system forms or the like.

### <First Content Search System>

The above object of the present invention can be also achieved by a first content search system provided with: the content search apparatus described above (including its various aspects); and the displaying device.

According to the first content search system of the present invention, it is provided with the aforementioned content search apparatus and the displaying device, so that the effect related to the content search apparatus described above is provided efficiently.

### <Second Content Search System>

The above object of the present invention can be also achieved by a second content search system, included in a network and including: a server apparatus; and at least one terminal apparatus, the terminal apparatus provided with: a display controlling device for controlling a displaying device to display at least two of a plurality of basic icons, each of which represents an attribute of a content, as operation target icons on a display screen of the predetermined displaying device; an operation information generating device for generating predetermined operation information if an input is given indicating that at least two of the operation target icons are to be combined, the operation information indicating that the at least two is to be combined; and a communicating device for transmitting the operation information to the server apparatus through the network, the server apparatus provided with: a first searching device for searching for a combined icon from the plurality of basic icons on the basis of a correspondence relationship set in advance if the transmitted operation information is obtained, the combined icon being defined as a combination of the at least two operation target icons to be combined; and a second searching device for searching for the content corresponding to the searched combined icon from the plurality of contents to which at least one value for defying the attribute is given in advance.

The second content search system of the present invention is included in the network and includes the server apparatus and the terminal apparatus.

Here, the “network” indicates a WAN (Wide Area Network), LAN (Local Area Network), or an Internet environment connected through the communication networks, or the like. The network conceptually includes the communication network that can be used by a special majority or an unspecified majority of users.

Here, the “server apparatus” conceptually includes various computer systems, such as a work station or a personal computer. Moreover, the “terminal apparatus” may vary for each user who uses the embodiment of the second content search system of the present invention. For example, the terminal apparatus can adopt various forms, such as various recording/reproducing apparatus for customer use (e.g. a hard disk recording apparatus, a DVD recording/reproducing apparatus, or the like), a personal computer, a mobile phone, a PDA, game equipment with a network function, a car audio system, and a car navigation system.

According to the second content search system of the present invention, the server apparatus is provided with the first searching device and the second searching device. That is, a process which belongs to a relatively heavy load category, such as the search for the combined icon and the search for the contents, is performed on the server apparatus side, so that it is possible to receive the effect of the present invention, efficiently. Incidentally, considering that the search is performed by the server apparatus through the network, for example, the terminal apparatus may receive some information corresponding to a result of the search process performed on the server apparatus side, through the network, from the serer apparatus.

Incidentally, in the second content search system of the present invention, the owner of the server apparatus may provide a content search service through the server apparatus, for the user who has paid to register, for example.

### <Server Apparatus for Content Search System>

The above object of the present invention can be also achieved by a server apparatus for a content search system, used in a content search system, included in a network with at least one terminal apparatus, the terminal apparatus provided with: a display controlling device for controlling a displaying device to display at least two of a plurality of basic icons, each of which represents an attribute of the content, as operation target icons on a display screen of the predetermined displaying device; an operation information generating device for generating predetermined operation information if an input is given indicating that at least two of the operation target icons are to be combined, the operation information indicating that the at least two is to be combined; and a communicating device for transmitting the operation information through the network, the server apparatus provided with: a first searching device for searching for a combined icon from the plurality of basic icons on the basis of a correspondence relationship set in advance if the transmitted operation information is obtained, the combined icon being defined as a combination of the at least two operation target icons to be combined; and a second searching device for searching for the content corresponding to the searched combined icon from the plurality of contents to which at least one value for defying the attribute is given in advance.

According to the server apparatus for the content search system of the present invention, it is possible to search for the content that matches the user's feeling or emotion, efficiently and effectively, by providing the same structure as that of the server apparatus in the second content search system of the present invention described above.

### <Content Search Method>

The above object of the present invention can be also achieved by a content search method for searching for predetermined types of contents on a display screen provided for a displaying device, the content search method provided with: a display controlling process of controlling the displaying device to display at least two of a plurality of basic icons, each of which represents an attribute of the content, as operation target icons on the display screen; a first searching process of searching for a combined icon from the plurality of basic icons on the basis of a correspondence relationship set in advance if an input is given indicating that at least two of the operation target icons are to be combined, the combined icon being defined as a combination of the at least two operation target icons to be combined; and a second searching process of searching for the content corresponding to the searched combined icon from the plurality of contents to which at least one value for defying the attribute is given in advance.

According to the content search method of the present invention, it is possible to obtain the same effect as that of the content search apparatus of the present invention, by the operation in each process, which is the same as that of the content search apparatus of the present invention.

### <First Computer Program>

The above object of the present invention can be also achieved by a first computer program making a computer system function as the content search apparatus described above (including its various aspects)

According to the computer program of the present invention, the aforementioned content search apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned content search apparatus of the present invention, the computer program of the present invention can also employ various aspects.

### <Second Computer Program>

The above object of the present invention can be also achieved by a second computer program making a computer system function as the terminal apparatus described above.

According to the computer program of the present invention, the aforementioned terminal apparatus in the second content search system of the present invention can be relatively easily realized as a computer reads and executes the computer program from a program storage device, such as a ROM, a CD-ROM, a DVD-ROM, and a hard disk, or as it executes the computer program after downloading the program through a communication device.

### <Third Computer Program>

The above object of the present invention can be also achieved by a third computer program making a computer system function as the server apparatus described above.

According to the computer program of the present invention, the aforementioned server apparatus in the second content search system of the present invention can be relatively easily realized as a computer reads and executes the computer program from a program storage device, such as a ROM, a CD-ROM, a DVD-ROM, and a hard disk, or as it executes the computer program after downloading the program through a communication device.

The above object of the present invention can be also achieved by a first computer program product in a computer-readable medium for tangibly embodying a program of instructions executable by a computer, the computer program product making the computer function as the aforementioned content search apparatus (including its various aspects).

The above object of the present invention can be also achieved by a second computer program product in a computer-readable medium for tangibly embodying a program of instructions executable by a computer, the computer program product making the computer function as the aforementioned terminal apparatus.

The above object of the present invention can be also achieved by a third computer program product in a computer-readable medium for tangibly embodying a program of instructions executable by a computer, the computer program product making the computer function as the aforementioned server apparatus.

According to each of the computer program products of the present invention, the aforementioned content search apparatus, terminal apparatus, or server apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned content search apparatus, terminal apparatus, or server apparatus of the present invention.

As explained above, the content search apparatus of the present invention is provided with the display controlling device, the first searching device, and the second searching device. Thus, it is possible to realize the search for the content that matches the user's feeling or emotion, efficiently and effectively.

As explained above, the content output apparatus with the search function of the present invention is provided with the outputting device in addition to the content search apparatus of the present invention. Thus, it is possible to realize the search for the content that matches the user's feeling or emotion, efficiently and effectively.

As explained above, the first content search system of the present invention is provided with the displaying device in addition to the content search apparatus of the present invention. Thus, it is possible to realize the search for the content that matches the user's feeling or emotion, efficiently and effectively.

As explained above, the second content search system of the present invention is provided with the server apparatus and the terminal apparatus. Thus, it is possible to realize the search for the content that matches the user's feeling or emotion, efficiently and effectively.

As explained above, the server apparatus for the content search system of the present invention is provided with the first searching device and the second searching device. Thus, it is possible to realize the search for the content that matches the user's feeling or emotion, efficiently and effectively.

As explained above, the content search method of the present invention is provided with the display controlling process, the first searching process, and the second searching process. Thus, it is possible to realize the search for the content that matches the user's feeling or emotion, efficiently and effectively.

As explained above, the first computer program of the present invention makes the computer system function as the content search apparatus of the present invention. Thus, it is possible to realize the search for the content that matches the user's feeling or emotion, efficiently and effectively.

As explained above, the second computer program of the present invention makes the computer system function as the terminal apparatus of the present invention. Thus, it is possible to realize the search for the content that matches the user's feeling or emotion, efficiently and effectively.

As explained above, the first computer program of the present invention makes the computer system function as the server apparatus of the present invention. Thus, it is possible to realize the search for the content that matches the user's feeling or emotion, efficiently and effectively.

These effects and other advantages of the present invention will become more apparent from the examples explained below.

### BRIEF DESCRIPTION OF DRAWINGS

FIG. 1 is a block diagram showing an on-vehicle audio apparatus in a first embodiment of the present invention.

FIG. 2 is a schematic diagram showing a music database provided for a music search apparatus which constitutes the on-vehicle audio apparatus in FIG. 1.

FIG. 3 is a schematic diagram showing music data in the music database in FIG. 2.

FIG. 4 is a flowchart showing a music search process.

FIG. 5 is a schematic diagram showing an initial setting screen.

FIG. 6 is a schematic diagram showing a display screen of a display apparatus.

FIG. 7 is another schematic diagram showing the display screen of the display apparatus.

FIG. 8 is another schematic diagram showing the display screen of the display apparatus.

FIG. 9 is another schematic diagram showing the display screen of the display apparatus.

FIG. 10 is another schematic diagram showing the display screen of the display apparatus.

FIG. 11 is a conceptual view showing a music search system in a second embodiment of the present invention.

FIG. 12 is a block diagram showing a server apparatus in the music search system in FIG. 11.

FIG. 13 is a block diagram showing a terminal apparatus in the music search system in FIG. 11.

### DESCRIPTION OF REFERENCE CODES

10 . . . on-vehicle audio apparatus, 20 . . . music search system, 21 . . . network, 100 . . . music search apparatus, 110 . . . control device, 111 . . . CPU, 120 . . . music list generation device, 130 . . . display control device, 140 . . . operation device, 150 . . . memory device, 151 . . . music DB, 152 . . . icon DB, 153 . . . icon conversion DB, 154 . . . search condition setting DB, 200 . . . display apparatus, 210 . . . display screen, 220 . . . icon selection area, 221, 222, 223, 224, 225, 226, 227, 228 . . . icon, 230 . . . icon setting area, 240 . . . search result display area, 250, 251 . . . icon, 260 . . . icon parts group, 261 . . . icon, 300 . . . music output device, 500a . . . terminal apparatus, 600 . . . server apparatus

### BEST MODE FOR CARRYING OUT THE INVENTION

Hereinafter, the best mode for carrying out the present invention will be explained in each embodiment in order with reference to the drawings.

### FIRST EMBODIMENT

### Structure of Embodiment

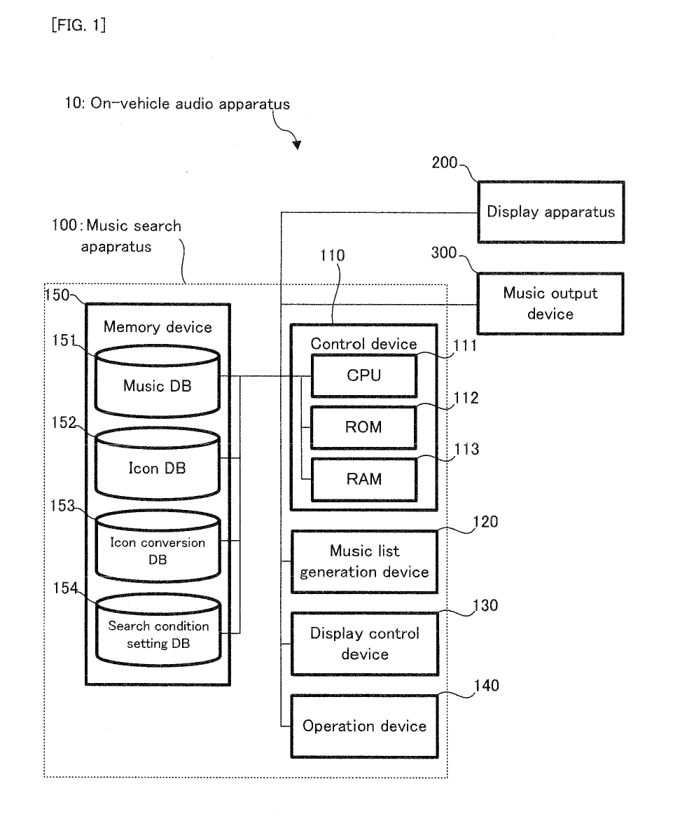

Firstly, with reference to FIG. 1, the structure of an on-vehicle audio apparatus in a first embodiment of the present invention will be explained. FIG. 1 is a block diagram showing an on-vehicle audio apparatus 10.

In FIG. 1, the on-vehicle audio apparatus 10 is provided with: a music search apparatus 100; a display apparatus 200; and a music output apparatus 300, and it is mounted on a not-illustrated vehicle. The on-vehicle audio apparatus 10 is also adapted to provide the music (i.e. one example of the “content” of the present invention) desired by an occupant who is a user in the vehicle. The on-vehicle audio apparatus 10 is one example of the “content output apparatus with the search function” of the present invention.

The music search apparatus 100 is provided with: a control device 110; a music list generation device 120; a display control device 130; an operation device 140; and a memory device 150. The music search apparatus 100 is one example of the “content search apparatus” of the present invention.

The control device 110 is provided with: a CPU (Central Processing Unit) 111; a ROM (Read Only Memory) 112; and a RAM (Random Access Memory) 113.

The CPU 111 is an electronic control unit which is adapted to control all the operations of the on-vehicle audio apparatus 10. The CPU 111 is constructed to function as one example of each of the “first searching device” and the “second searching device” of the present invention.

The ROM 112 is a non-volatile memory apparatus for storing therein various control programs which can be executed by the CPU 111. The ROM 112, in particular, stores therein a control program for performing a music search process described later, and the CPU 111 is adapted to perform the music search process in accordance with the control program.

The RAM 113 is a buffer memory which is adapted to temporarily store therein various data which is generated in the course of the CPU 111's performing the music search process.

The music list generation device 120 is adapted to generate a list of searched music, which is one example of the “content information” of the present invention. The music list generation device 120 is one example of the “content information generating device” of the present invention.

The display control device 130 is an image control unit which is adapted to control the display apparatus 200 to display various information including information about the music search process, on a display screen 210 (not illustrated in FIG. 1) provided for the display apparatus 200. The display control device 130 is one example of the “display controlling device” of the present invention.

The operation device 140 is an input device which is operated by the user of the on-vehicle audio apparatus 10, and the operation device 140 is one example of the “inputting device” of the present invention. In this embodiment, the operation device 140 is constructed as a touch panel input apparatus including a touch panel apparatus and a pen input device. In particular, the touch panel apparatus is unified with the display screen 210 of the display apparatus 200. When the user performs various operations on the display screen 210 with the pen input device, output signals corresponding to the various operations are outputted from the touch panel apparatus. The control device 110 is constructed to perform a process corresponding to the user's operation on the basis of the output signal which is outputted as occasion demands.

The memory device 150 is provided with: a music database (hereinafter referred to as a “music DB” as occasion demands) 151; an icon database (hereinafter referred to as an “icon DB” as occasion demands) 152; an icon conversion database (hereinafter referred to as an “icon conversion DB” as occasion demands) 153; and a search condition setting database (hereinafter referred to as a “search condition setting DB” as occasion demands) 154. The memory device 150 is a high-capacity memory apparatus, which is one example of the “memory device” of the present invention.

The music DB 151 is a database which stores therein various data about a large amount of music, which become a search target in the music search process. Incidentally, the details of the music DB 151 will be described later.

The icon DB 152 is a database which stores therein data about various icons (i.e. one example of the “basic icon” of the present invention) for specifying a search condition in the music search process.

The icon conversion DB 153 is a database which stores therein data about a correspondence relationship among the icons that are stored in the icon DB 152 in the music search process.

The search condition setting DB 154 is a database for converting an attribute, described later, which is given to the icon specified as the search condition, into a format that allows the music search from the music DB 151, in the music search process.

The display apparatus 200 is provided with the display screen 210 (not illustrated), which is a liquid crystal display, and it is adapted to display the various information and various information screens related to the music search process. The display apparatus 200 is one example of the “displaying device” of the present invention.

The music output device 300 includes various processing units (e.g. an amplifier, a speaker, and the like) for sounding the various music searched for by the music search process, in the vehicle. The music output device 300 is one example of the “outputting device” of the present invention.

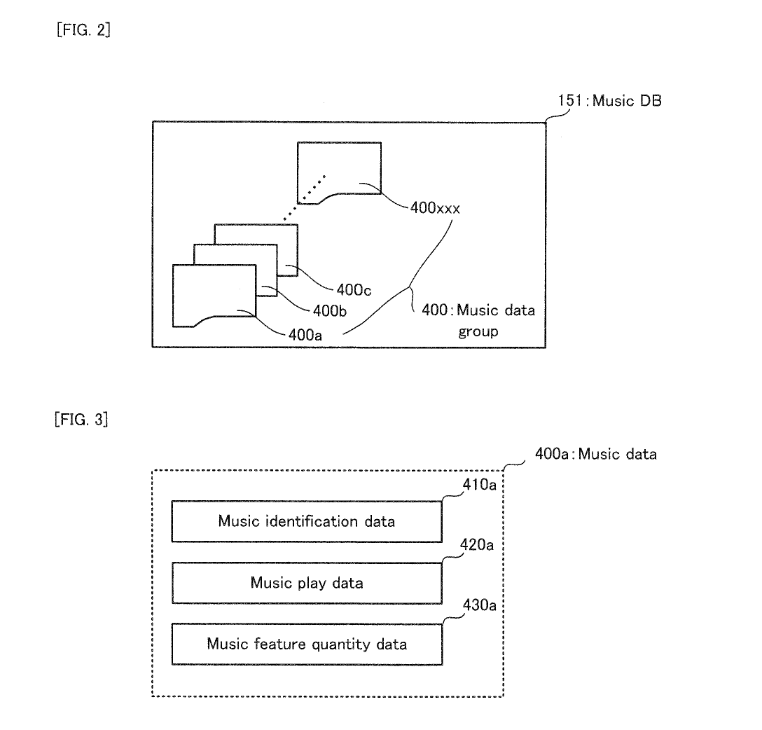

Next, with reference to FIG. 2, the details of the music DB 151 will be described. FIG. 2 is a schematic diagram showing the music DB 151.

In FIG. 2, the music DB 151 stores therein a music data group 400 composed of music data 400a, 400b, 400c, . . . , 400xxx, each of which corresponds to respective one of a plurality of music songs. Now, further, with reference to FIG. 3, the individual music data is described. FIG. 3 is a schematic diagram showing the music data 400a. Incidentally, in FIG. 3, the duplicate points of those in FIG. 2 carry the same numerical references, and the explanation thereof will be omitted as occasion demands. Moreover, FIG. 3 shows one music data 400a in FIG. 2; however, the other music data also have the same music data structure.

In FIG. 3, the music data 400a includes: music identification data 410a; music play data 420a; and music feature quantity data 430a.

The music identification data 410a is information for identifying the music, e.g. data about a music title, its artist name, and the like. The music identification data 410a is used for index display of the search result or the like if the music data group 400 is searched for the individual music data.

The music play data 420a is sound data for playing the music data 400a. The music play data 420a can sound the music corresponding to the music data 400a in the vehicle, on the basis of the music play data 420a.

The music feature quantity data 430a is data indicating music feature quantities (i.e. one example of the “value for defining the attribute” of the present invention) about a plurality of music feature items which are set as what define the attributes of the individual music songs.

The music feature items are composed of many items corresponding to the attributes represented by the icons stored in the icon DB 152. In the embodiment, the music feature items include: quantitative items, such as brightness, sadness, tempo, enjoyment, happiness, calmness, and frustration; and specific feature items, such as weather, season, situation, and genre. Moreover, each of the specific feature items is further segmentalized. For example, the music feature item about the weather is further segmentalized into sunny, rainy, cloudy, snowy, stormy, and the like. In the same manner, the season is further segmentalized into spring, summer, autumn, winter, rainy season, and the like. The situation is further segmentalized into drive, wedding ceremony, chirstmas, party, beach, festival, and the like. The genre is further segmentalized into, male vocal, female vocal, group, love song, broken-heart song, and the like.

The music feature quantities adopt different forms between the quantitative music feature items and the specific music feature items. For example, the music feature quantities in the quantitative music feature items are quantified values indicating the degree of a feeling element indicated by the quantitative music feature items. For example, the music feature quantities adopt any of the smallest degree of value “1” to the largest degree of value “5”. For example, if the music feature item of “brightness” has the music feature quantity of “5”, it indicates that the music is extremely cheerful.

On the other hand, the music feature quantities in the specific music feature items adopt any of two values of “0” and “1”, which indicates whether or not the music corresponds to each of the specific music feature items; namely, a form of flag. For example, if the music feature quantity of “1” is given to the music feature item of “love song”, it indicates that the music is a love song. In the embodiment, the music feature items and the music feature quantities are given in advance by a provider of the music; however, it is also possible for the user to set them individually and specifically, of course.

Incidentally, the types of the music feature items, the aspect of setting the music feature quantities and the like are, of course, merely one example, and a change can be arbitrarily provided in the scope of the concept of the present invention.

### Operation of Embodiment

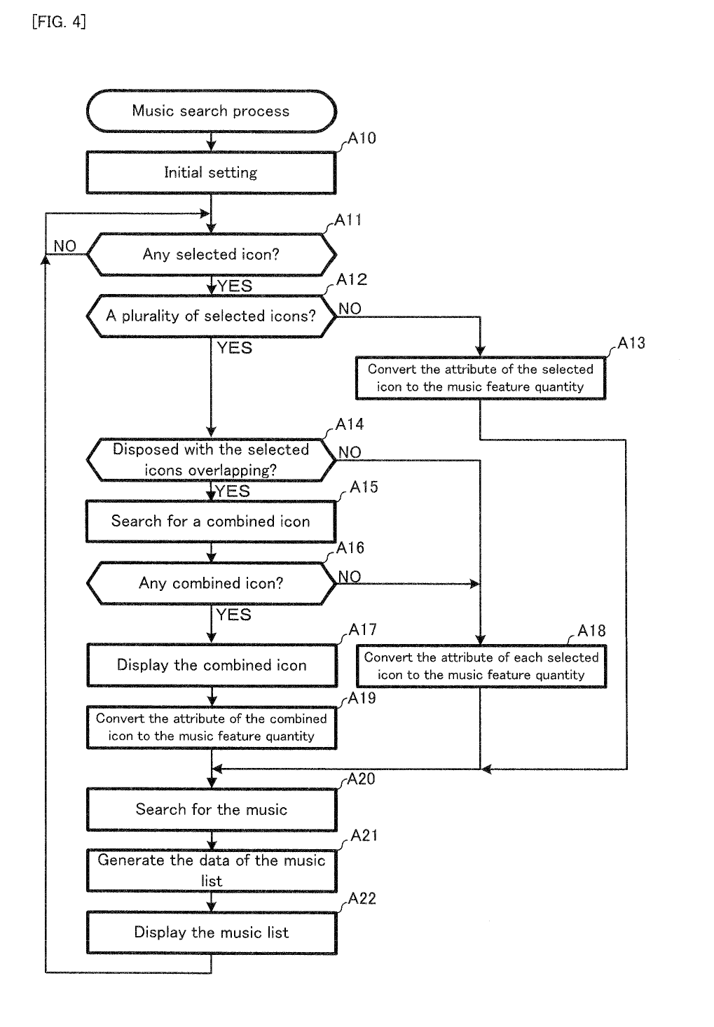

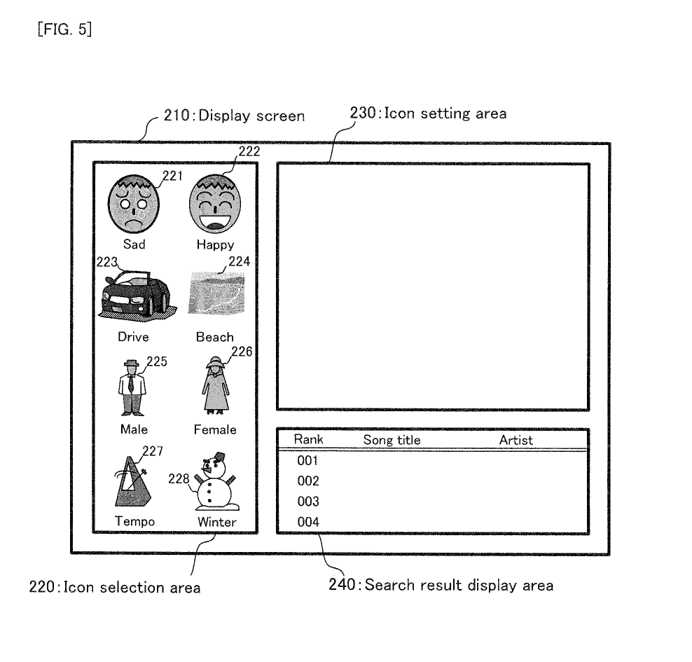

The CPU 111 provided for the control device 110 can perform the music search process for searching for the music in accordance with a control program (i.e. one example of the “computer program” of the present invention) stored in the ROM 112. Now, with reference to FIG. 4, the details of the music search process are described. FIG. 4 is a flowchart showing the music search process.

In FIG. 4, the CPU 111 performs initial setting (step A10). In the initial setting, the CPU 111 controls the display control device 130 to display an initial setting screen on the display screen 210 of the display apparatus 200. Now, with reference to FIG. 5, the initial setting screen is described. FIG. 5 is a schematic diagram showing the initial setting screen.

In FIG. 5, on the display screen 210 of the display apparatus 200, an icon selection area 220, an icon setting area 230, and a search result display area 240 are displayed as the initial setting screen.

The icon selection area 220 displays one portion of the plurality of icons stored in the icon DB 152, wherein default display is set in the one portion. In the embodiment, eight icons are displayed; namely, an icon 221 with an attribute of “sad”, an icon 222 with an attribute of “happy”, an icon 223 with an attribute of “drive”, an icon 224 with an attribute of “beach”, an icon 225 with an attribute of “male”, an icon 226 with an attribute of “female”, an icon 227 with an attribute of “tempo”, and an icon 228 with an attribute of “winter”.

Incidentally, the icon DB 152 stores therein the data about a large amount of icons; however, basically it is only the icons displayed in the icon selection area 220 that the user can directly operate through the operation device 140. That is, each of the icons displayed in the icon selection area 220 is one example of the “operation target icon” of the present invention.

The icon setting area 230 is a display area in which the icon to be specified as the search condition is disposed. The CPU 111 starts to search for the music corresponding to the icon when the icon is disposed in the icon setting area 230.

The search result display area 240 is an area in which the music search result is displayed. In the default setting, three types of information, which are a search rank, a song title, and an artist name, are displayed in the search result display area 240. The content displayed in the search result display area 240 can be arbitrarily changed in a range set in advance.

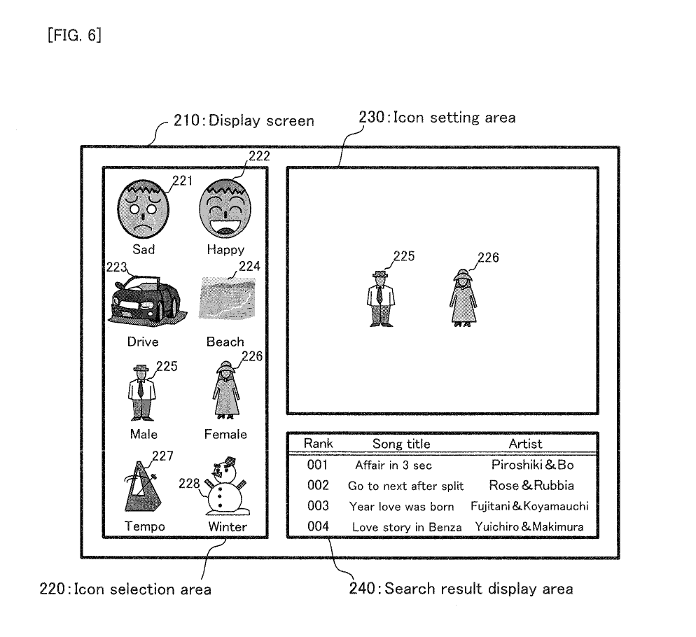

Back in FIG. 4, when the initial setting is ended, the CPU 111 judges whether there is any selected icon (step A11). Here, the selected icon indicates the icon that is selected from the icon selection area 220 and is disposed in the icon setting area 230. Now, with reference to FIG. 6, the selected icon is described. FIG. 6 is a schematic diagram showing the display screen 210. Incidentally, in FIG. 6, the duplicate points of those in FIG. 5 carry the same numerical references, and the explanation thereof will be omitted as occasion demands.

In FIG. 6, in the icon setting area 230, the icon 225 and the icon 226 are displayed as the selected icons. The icon 225 is an icon with the attribute of “male” given, and the icon 226 is an icon with the attribute of “female” given.

Back in FIG. 4 again, if there is no selected icon (the step A11: NO), the CPU 111 repeats the process related to the step A11 and holds the process. On the other hand, if there is the selected icon (the step A11: YES), the CPU 111 further judges whether or not there are a plurality of selected icons (step A12). If there are the plurality of selected icons (the step A12: YES), the CPU 111 further judges whether or not the selected icons are disposed with them overlapping (step A14).

If the selected icons are not disposed with them overlapping (the step A14: NO), the CPU 111 converts the attribute of each of the selected icons to the music feature quantity (step A18). At this time, the CPU 111 specifies the attribute given to each of the selected icons, from the icon DB 152, and it searches for the music feature quantity corresponding to the specified attribute, with reference to the search condition setting DB 154.

Now in FIG. 6 again, the icon 225 and the icon 226 are disposed in parallel with each other in the icon setting area 230, which corresponds to the status that the judgment process in the step A14 in FIG. 4 is “NO”. At this time, in the process in the step A18 in FIG. 4, the CPU 111 sets, as the search condition, a numerical value of “1” in the music feature item of the “male vocal”, as the music feature quantity corresponding to the attribute of “male”, which is given to the icon 225. Moreover, the CPU 111 sets, as the search condition, a numerical value of “1” in the music feature item of the “female vocal”, as the music feature quantity corresponding to the attribute of “female”, which is given to the icon 226, and temporarily stores it into the RAM 113. That is, in the status of the icon setting area shown in FIG. 6, the music that has flags planted in the music feature items of male vocal and female vocal is searched for.

Back in FIG. 4, if the attribute of the selected icon is converted to the music feature quantity, the CPU 111 searches the music data in the music DB 151 for the music that has the music feature quantity converted as the music search condition, with reference to the music feature quantity data (step A20). That is, the music with the music feature quantity of “1” given to each of the music feature items of male vocal and female vocal is searched for.

When the music is searched for, the CPU 111 instructs the music list generation device 120 to generate list data for displaying a list of the searched music. The music list generation device 120 generates display data for displaying the music list in the search result display area 240, with reference to the music identification data of the music data corresponding to the respective searched music (step A21).

The generated display data is temporarily stored into the RAM 113, and then it is displayed on the display apparatus 200 in accordance with the control of the display control device 130 instructed by the CPU 111 (step A22).

Back in FIG. 6, through such a process, the music corresponding to both the attributes of male vocal and female vocal, i.e. a duet, is displayed as the search result in the search result display area 240.

Back in FIG. 4, if there is a single selected icon (the step A12: NO), the CPU 111 converts the attribute of the single selected icon to the music feature quantity as the search condition, as in the case that there are the plurality of selected icons described above (step A13). After that, in the same manner, the music is searched for and is displayed as the list.

Here, there are only eight icons displayed in the icon selection area 220, and in this situation it is hard to say that the music that matches the user's feeling or emotion is sufficiently searched for. However, it is hard to display all the icons that are stored in the icon DB 152, in the icon selection area 220, and furthermore, even if all the icons can be displayed, it is remarkably hard that the user finds and selects the desired icon therefrom. Thus, in the music search process in the embodiment, the problem is solved in the following manner.

Back in FIG. 4, if the selected icons are disposed with them overlapping (the step A14: YES), the CPU 111 searches for a combined icon of the selected icons disposed with them overlapping (step A15). At this time, the CPU 111 searches for the combined icon on the basis of the data indicating a correspondence relationship among the icons stored in the icon conversion DB 153. The combined icon indicates an icon which is estimated on the basis of the concept of each of the attributes of the plurality of icons and which has an attribute independent of the above attributes. In the icon conversion DB 153, the icon that is a target of the combination and the icon that is a result of the combination (i.e. combined icon) are stored as the data, with regard to each of all the icons in which the combination relationship is set.

Incidentally, an input requiring the search for the combined icon adopts, but of course is not limited to, such an aspect that the icons are disposed with them mutually overlapping, in the embodiment. For example, the search for the combined icon may be performed by operating (e.g. pressing) some button or switch or the like in the condition that the plurality of icons, which are the combination targets, are selected.

If the combined icon is searched for, the CPU 111 judges whether or not there is the combined icon (step A16). If the combination relationship between the icons disposed with them overlapping is not set and there is no combined icon (the step A16: NO), the CPU 111 converts the attribute of each of the selected icons to the music feature quantity, as described above (step A18).

If there is the combined icon (the step A16: YES), the CPU 111 selects the data about the relevant icon from the icon DB 152 and displays it as the selected icon in the icon setting area 230 through the display control device 130 (step A17). At the same time, the CPU 111 converts the attribute represented by the combined icon displayed in the icon setting area 230, to the music feature quantity, and sets it as the music search condition (step A19). After that, as described above, the search for the music is performed, and the music list is eventually displayed in the search result display area 240 (step A22). If the music list is displayed, the CPU 111 returns the process to the step A11 and repeats a series of processes.

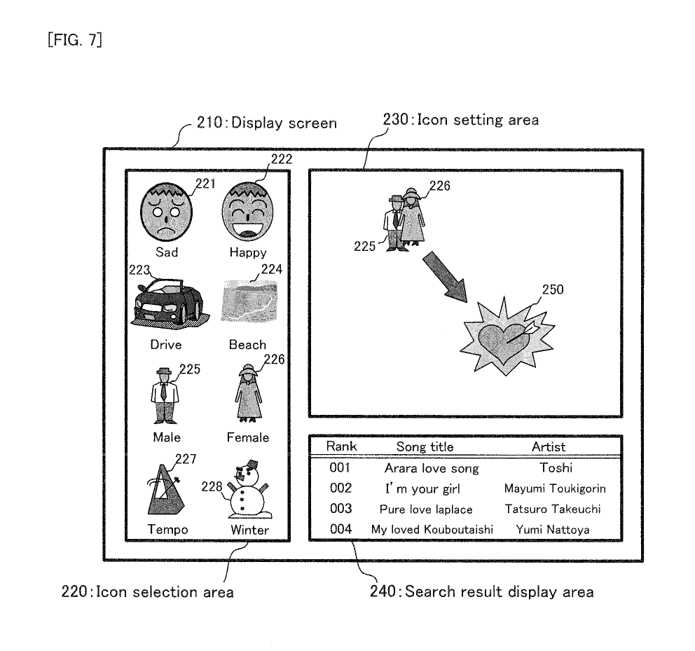

Now a description is given on the status that the selected icons are combined, with reference to FIG. 7. FIG. 7 is another schematic diagram showing the display screen 210. Incidentally, in FIG. 7, the duplicate points of those in FIG. 6 carry the same numerical references, and the explanation thereof will be omitted as occasion demands as occasion demands.

In FIG. 7, the icon 225 and the icon 226 overlap with each other in the icon setting area 230. As a result, an icon 250 representing the attribute of “love song” is searched for as the combined icon, and is displayed in the icon setting area 230. Along with that, not the aforementioned duet but the music that the music feature quantity of “1” is given to the music feature item of the love song, i.e. love song, is displayed as the search result, in the search result display area 240.

Incidentally, in the embodiment, the search result of the music (content(s)) is displayed as the music list in the search result display area; however, there is no limitation in an aspect of presenting the search result to the user, as long as the search result can be presented or transmitted to the user. For example, the presentation of the search result to the user may be performed by sequentially reproducing, or performing similar actions on, one portion of the music corresponding to the search result, such as an introduction part and a highlight part if the content is the music. Or the presentation of the search result to the user may be performed by sequentially reproducing a highlight of the video or a promotional video corresponding to the search result if the content is the video.

As described above, in the music search process in the first embodiment, the limited icons, which are displayed in the icon selection area 220, are overlapped as occasion demands in the icon setting area 230, to thereby call up an icon that has not been displayed yet, in the icon selection area 220 and set it as the search condition. Therefore, in the condition that the number of icons displayed in the icon selection area 220 is suppressed to be low enough not to reduce the user's visibility, operability, and the like, it is possible to set more attributes than those simply given to the displayed icons, as the search condition. That is, it is possible to search for the content that matches the user's feeling or emotion, efficiently and effectively.

Incidentally, if the music list, which is the search result of the music, is referred to, and if an input is given indicating that one of the music is to be played, the CPU Ill obtains music play data from the music data about the relevant music of all the music data included in the music DB 151, and supplies it to the music output device 300. The music output device 300 controls each play process unit on the basis of the supplied music play data and sounds the music in the vehicle. Incidentally, the CPU 111 may start to play the music, sequentially from the top of the search rank of the music list, at the time point that the music list is displayed in the search result display area 240. That is, the music output device 300 may be used for the presentation of the search result.

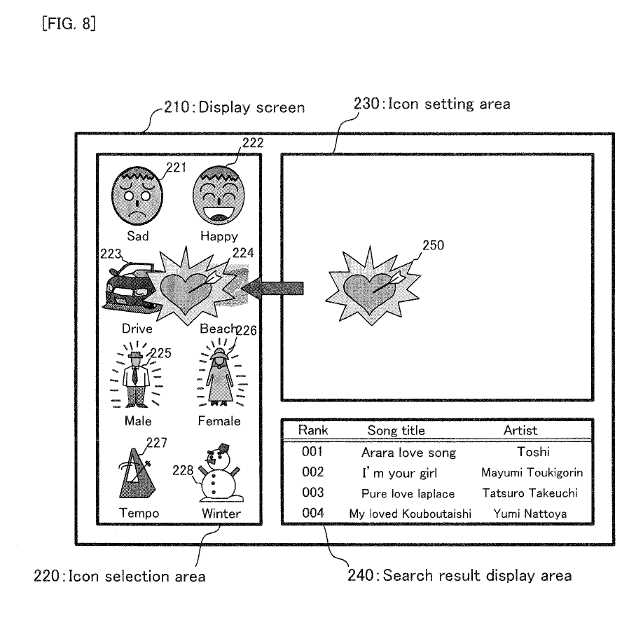

Incidentally, even if the combined icon can be displayed by combining the individual selected icons, a guide for which icons are to be combined to obtain the desired icon is required in the initial use of the music search apparatus 100 in some cases. FIG. 8 shows one portion of the function of the music search apparatus 100 which can handle such a case. FIG. 8 is another schematic diagram showing the display screen 210. Incidentally, in FIG. 8, the duplicate points of those in FIG. 7 carry the same numerical references, and the explanation thereof will be omitted as occasion demands as occasion demands.

In FIG. 8, it is assumed that a certain combined icon (the icon 250 in FIG. 8) is displaced from the icon setting area 230 to the icon selection area 220 (refer to an arrow in FIG. 8). In this case, the CPU 111 controls the display control device 130 to highlight the icon 225 and the icon 226, such as flashing the icons. That is, the CPU 111 functions as one example of the “fourth searching device” of the present invention. As a result, the icon 225 and the icon 226 are highlighted, and the user can visually recognize that the icon 250 corresponds to a combination of the icon 225 and the icon 226.

Moreover, it is possible not only to search for the icons which constitute the combined icon from the combined icon, but also to search for the icons from the music. For example, it is assumed that an index of the music stored in the music DB 151 is displayed (which can be easily performed on the basis of the music identification data) through a predetermined operation, independently of the search result displayed in the search result display area 240. In this case, if the user specifies one music song from the index, the CPU 111 may control the display control device 130 to display all the icons corresponding to the specified music in the icon setting area 230. That is, in this case, the CPU 111 functions as one example of the “third searching device” of the present invention. Moreover, if there is the combined icon among the displayed icons, it is possible to further search for the icons that constitute the combined icon, as shown in FIG. 8. In this manner, the user can obtain the guide in searching for the music in a short time and to perform the music search efficiently.

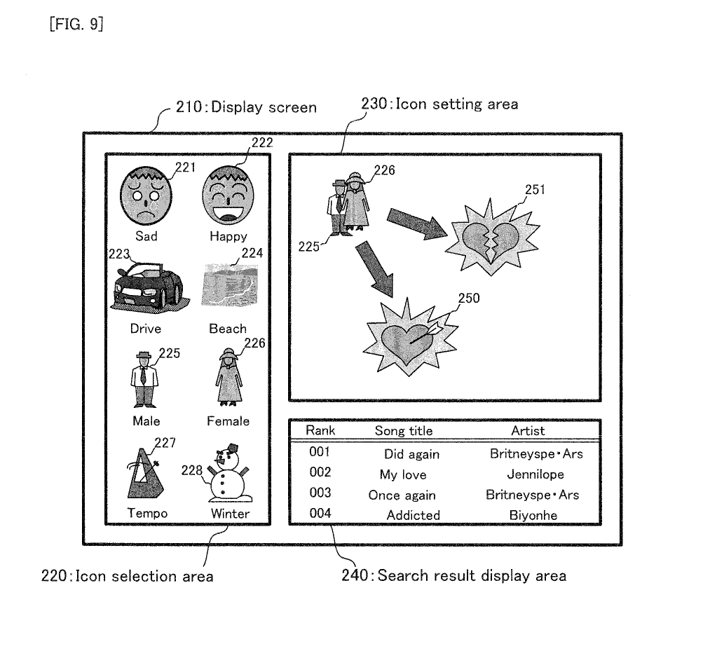

Incidentally, in the process related to the step A17 in the music search process shown in FIG. 4, in some cases, there are a plurality of relevant combined icons. In that case, the CPU 111 may display all the combined icons, of course. Now, with reference to FIG. 9, a description is given on such a case that there are the plurality of combined icons. FIG. 9 is another schematic diagram showing the display screen 210. Incidentally, in FIG. 9, the duplicate points of those in FIG. 7 carry the same numerical references, and the explanation thereof will be omitted as occasion demands as occasion demands.

In FIG. 9, in the icon setting area 230, there is displayed an icon 251 in addition to the icon 250 shown in FIG. 7. The icon 251 is an icon representing the attribute of “broken heart”, and it represents the opposite attribute to that of the icon 250 representing the attribute of “love song”. In this case, as the search result related to the music search process, the CPU 111 displays the music list including the music about the love song and the broken heart, in the search result display area 240.

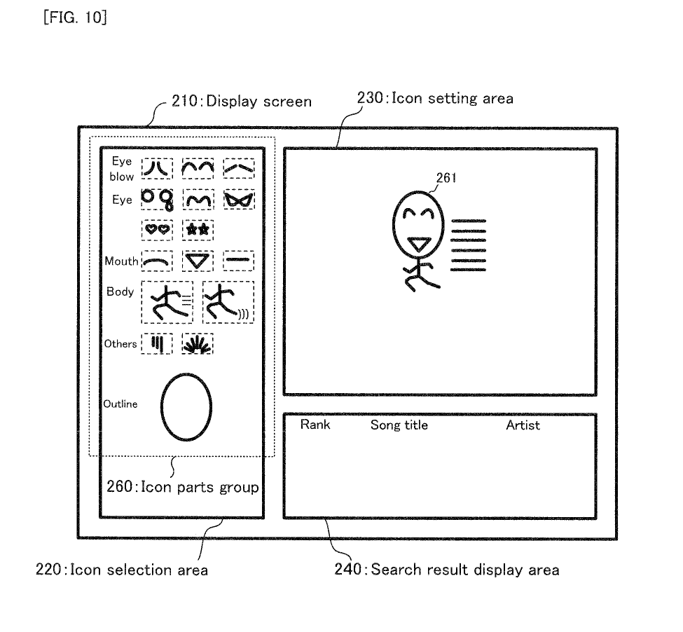

Moreover, the icons that are used to search for the music in the embodiment are not limited to those stored in advance in the icon DB152, but can be generated by the user. Such a function of the music search apparatus 100 will be explained with reference to FIG. 10. FIG. 10 is another schematic diagram showing the display screen 210. Incidentally, in FIG. 10, the duplicate points of those in FIG. 5 carry the same numerical references, and the explanation thereof will be omitted as occasion demands as occasion demands.

In FIG. 10, an icon parts group 260 provided with a plurality of icon parts is displayed in the icon selection area 220. The icon parts included in the icon parts group 260 are stored in the icon DB 152 in advance, in association with the attribute represented by each of the icon parts. The CPU 111 controls the display control device 130 to display one portion of the icon parts stored in the icon DB 152 if an input prompting the start of a predetermined icon generation mode is given from the operation device 140. As a result, the icon parts group 260 is displayed in the icon selection area 220. Incidentally, the icon parts included in the icon parts group 260 can be arbitrarily selected by the user.

If the icon parts group 260 is displayed, the user arbitrarily combines the icon parts which constitute the icon parts group 260. Specifically the user selects and displaces the individual icon parts to the icon setting area 230, to thereby generate a new icon.

The CPU 111 performs a predetermined generation process on the selected and displaced icon parts, and displays a newly generated icon 261 in the icon setting area 230. Moreover, if an input indicating that it is desired to store the icon 261 is given from the operation device 140, the CPU 111 refers to the attribute given in advance to each of the icon parts included in the icon 261, and gives a new attribute to the icon 261. For example, the icon parts included in the icon 261 include a body with an uplifting feeling, a wide-open mouth, and kind eyes. The CPU 111 gives e.g. an attribute of “happy and high tempo” to the icon 261. The icon 261 to which the new attribute is given is stored as the icon into the icon DB 152. At the same time, the CPU 111 generates the data about the music feature quantity indicating the search condition corresponding to the attribute of the icon 261, and stores it into the search condition setting DB 154. That is, in this case, the CPU 111 functions as one example of the “icon generating device” and the “icon registering device” of the present invention. If the icon 261 is regarded as the selected icon in the aforementioned music search process, for example, music songs that are happy and has high tempo are searched for from the music DB 151, and they are displaced as the music list in the search result display area 240.

Incidentally, the search condition in this case is “happy and high tempo”, and this is not the specific search condition in the explanation on the music search process. In order to reflect the qualitative attribute in the search condition, the correspondence relationship between the attribute represented by each icon and the music feature quantity, which is the search condition, is given as the data in the search condition setting DB 154. For example, as described above, what is set as the search condition data for the attribute of the icon 225 is that the music feature quantity of the music feature item of “male vocal” is “1”. As for the qualitative attribute, such as happy and high tempo, what are set as the search condition data are that the music feature quantity of the music feature item of “happy” is 4 or more and that the music feature quantity of the music feature item of “high tempo” is 4 or more.

### SECOND EMBODIMENT

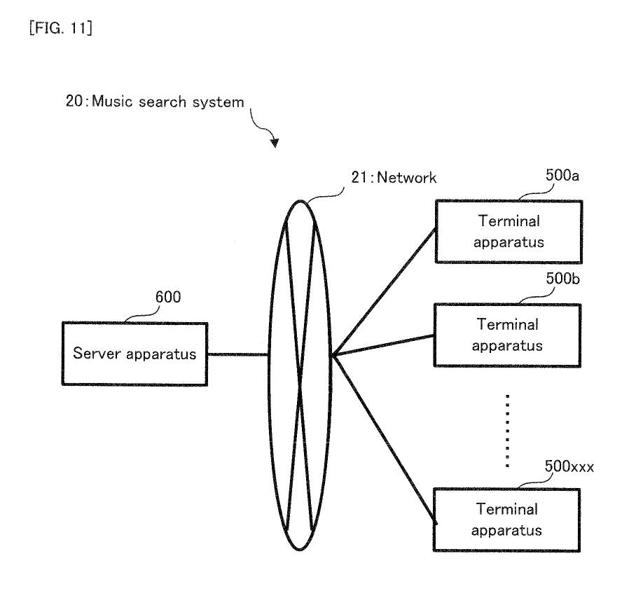

The music search method of the present invention can be achieved even through a network. Now, such a second embodiment of the present invention is explained with reference to FIG. 11. FIG. 11 is a conceptual view showing a music search system 20 in the second embodiment of the present invention.

The music search system 20 is a system included in a network 21 which is a wide area network, such as the Internet. The music search system 20 includes a server apparatus 600 and a plurality of terminal apparatuses 500a, 500b, . . . , 500xxx.

The server apparatus 600 is provided by a not-illustrated provider which develops a music search service on the network 21, and the server apparatus 600 provides the music search service for a plurality of users who have gone through a predetermined authentication procedure. Each of the terminal apparatuses is possessed by the user, and it adopts a portable form, such as a mobile phone.

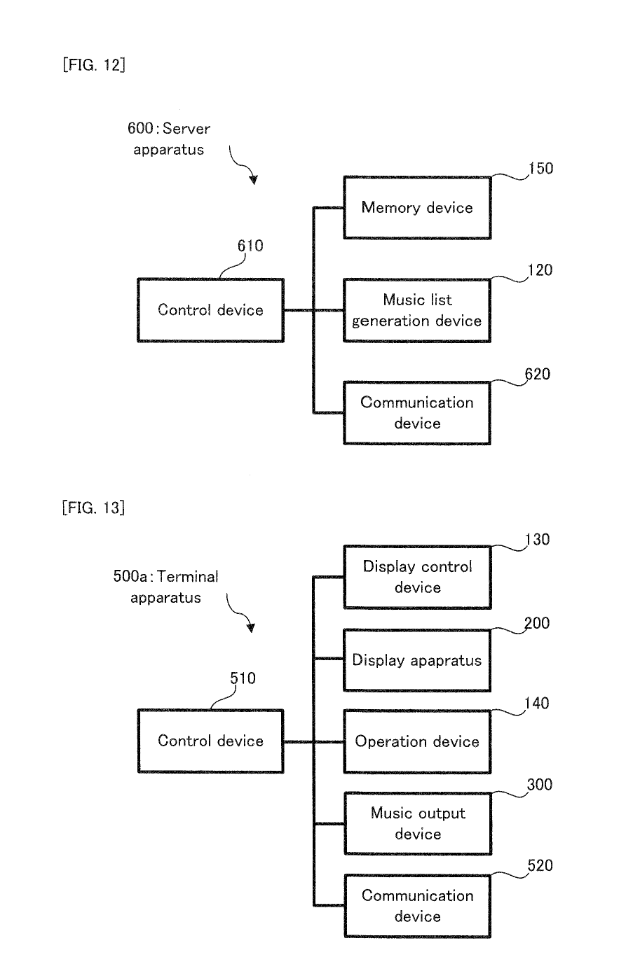

Next, with reference to FIG. 12, the detailed structure of the server apparatus 600 will be described. FIG. 12 is a block diagram showing the server apparatus 600. Incidentally, in FIG. 12, the duplicate points of those in FIG. 1 carry the same numerical references, and the explanation thereof will be omitted as occasion demands.

In FIG. 12, the server apparatus 600 is provided with: a control device 610; a music list generation device 120; a memory device 150; and a communication device 620. The server apparatus 600 is one example of the “server apparatus for the music search system” of the present invention.

The control device 610 is a control unit for controlling the operations of the serer apparatus 600, and it is constructed to perform one portion of the function of the control device 110 in the first embodiment.

The communication device 620 is a communication interface which can perform a data communication with each of the terminal apparatuses through the network 21.

Next, with reference to FIG. 13, a description will be given on the detailed structure of the terminal apparatus 500a. FIG. 13 is a block diagram showing the terminal apparatus 500a. Incidentally, in FIG. 13, the duplicate points of those in FIG. 1 carry the same numerical references, and the explanation thereof will be omitted as occasion demands. Incidentally, the structure of the terminal apparatus is common among the terminal apparatuses, and the description on one terminal apparatus also explains the other terminal apparatuses.

In FIG. 13, the terminal apparatus 500a is provided with: a control device 510; a display control device 130; an operation device 140; a display apparatus 200; a music output device 300; and a communication device 520. The terminal apparatus 500a is one example of the “terminal apparatus” of the present invention.

The control device 510 is a control unit for controlling all the operations of the terminal apparatus 500a, and it is constructed to perform one portion of the function of the control device 110 in the first embodiment.

The communication device 520 is a communication interface which can perform a data communication with the server apparatus 600 through the network 21. The communication device 520 is one example of the “communicating device” of the present invention.

Under the construction, in the music search system 20, the control device 610 generates initial setting data and transmits it to each terminal apparatus through the communication device 620 at the start of the music search service. In receiving the transmission of the initial setting data, the same initial setting screen as that in the first embodiment is displayed on the display apparatus 200 in each terminal apparatus.

If some operation (e.g. an operation about icon selection, icon combination, or icon generation or the like) is performed on the initial setting screen, the control device 510 generates operation content data indicating the content of the operation, and transmits it to the server apparatus 600 through the communication device 520.

The server apparatus 600, in response to the transmission of the operation content data, performs the process related to the music search as in the first embodiment, and generates display data for displaying the list of the music searched on the display apparatus 200. The generated display data is transmitted to the terminal apparatus 500a again through the communication device 620. As a result, the search result of the music is displayed on the display apparatus 200 of the terminal apparatus 500a, as in the first embodiment.

As described above, in the music search system 20 in the second embodiment, a huge amount of data about the music and the icons is provided for the memory apparatus on the server apparatus 600 side, and moreover, a process with a relatively heavy load, such as the combination of the icons and the search for the music, is also performed on the server apparatus 600 side. Therefore, on each terminal apparatus, the music can be simply searched for by performing operations, as occasion demands, on the display screen of the display apparatus 200, and it is possible to search for the music that matches the user's feeling or emotion, efficiently and effectively.

The present invention is not limited to the above-described embodiment, and various changes may be made, if desired, without departing from the essence or spirit of the invention which can be read from the claims and the entire specification. A content search apparatus, a content search system, a server apparatus for a content search system, a content search method, a computer program, and a content output apparatus with a search function, which involve such changes, are also intended to be within the technical scope of the present invention.

### INDUSTRIAL APPLICABILITY

The content search apparatus, the content search system, the server apparatus for the content search system, the content search method, the computer program, and the content output apparatus with a search function according to the present invention can be applied to a content search apparatus, a content search system, a server apparatus for a content search system, and a content search method, which are to search for various contents, such as music, and a content output apparatus with a search function or the like for searching for and outputting such contents. Moreover, they can be also applied to a content search apparatus, a server apparatus for a content search system, or the like which is mounted on various computer equipment for consumer use or for commercial use, or which can be connected to various computer equipment.

1. A content search apparatus for searching for predetermined types of contents on a display screen provided for a displaying device, said content search apparatus comprising:
a display controlling device for controlling the displaying device to display at least two of a plurality of basic icons, each of which represents an attribute of the content, as operation target icons on the display screen;
a first searching device for searching for a combined icon from the plurality of basic icons on the basis of a correspondence relationship set in advance if an input is given indicating that at least two of the operation target icons are to be combined, the combined icon being defined as a combination of the at least two operation target icons to be combined; and
a second searching device for searching for the content corresponding to the searched combined icon from the plurality of contents to which at least one value for defying the attribute is given in advance.

2. The content search apparatus according to claim 1, wherein said display controlling device further controls the displaying device to display the searched combined icon on the display screen.

3. The content search apparatus according to claim 1, further comprising a content information generating device for generating content information corresponding to the searched content,
said display controlling device further controlling the displaying device to display the content information on the display screen.

4. The content search apparatus according to claim 3, wherein said content information generating device generates a list of the searched content as at least one portion of the content information.

5. The content search apparatus according to claim 1, wherein said first searching device searches for the combined icon if such an operation is performed that the at least two operation target icons are disposed with them mutually overlapping in a predetermined area on the display screen, as at least one portion of the input indicating that the at least two are to be combined.

6. The content search apparatus according to claim 1, wherein said display controlling device further controls the displaying device to newly display the searched combined icon on the display screen as one portion of the operation target icons, in response to an input indicating that the searched combined icon is to be added to the operation target icons.

7. The content search apparatus according to claim 1, further comprising a third searching device for searching for the basic icon corresponding to specified one content from the plurality of basic icons on the basis of the value for defying the attribute given to the specified one content if an input is given indicating that the one content is to be specified from the plurality of contents, said display controlling device controlling the displaying device to display the basic icon corresponding to the specified one content, on the display screen.

8. The content search apparatus according to claim 7, further comprising a fourth searching device for searching for a plurality of basic icons that constitute the basic icon corresponding to the specified one content from the plurality of basic icons if the basic icon corresponding to the specified one content is one combined icon,
said display controlling device controlling the displaying device to display the plurality of basic icons that constitute the basic icon corresponding to the specified one content, on the display screen.

9. The content search apparatus according to claim 1, further comprising:
an icon generating device for newly generating an icon by combining a plurality of parts, selected from a plurality of parts set in advance, on the display screen; and
an icon registering device for newly registering the generated icon as the basic icon by giving the attribute to the generated icon.

10. The content search apparatus according to claim 1, further comprising an inputting device capable of performing predetermined types of inputs including the input indicating that the at least two operation target icons are to be combined.

11. The content search apparatus according to claim 1, further comprising a memory device for storing the plurality of contents.

12. A content output apparatus with a search function, comprising:
the content search apparatus according to claim 1; and
an outputting device for outputting the searched content.

13. A content search system comprising:
the content search apparatus according to claim 1; and
the displaying device.

14. A content search system, included in a network and including: a server apparatus; and at least one terminal apparatus,
said terminal apparatus comprising:
a display controlling device for controlling a displaying device to display at least two of a plurality of basic icons, each of which represents an attribute of a content, as operation target icons on a display screen of the predetermined displaying device;
an operation information generating device for generating predetermined operation information if an input is given indicating that at least two of the operation target icons are to be combined, the operation information indicating that the at least two is to be combined; and
a communicating device for transmitting the operation information to said server apparatus through the network,
said server apparatus comprising:
a first searching device for searching for a combined icon from the plurality of basic icons on the basis of a correspondence relationship set in advance if the transmitted operation information is obtained, the combined icon being defined as a combination of the at least two operation target icons to be combined; and
a second searching device for searching for the content corresponding to the searched combined icon from the plurality of contents to which at least one value for defying the attribute is given in advance.

15. A server apparatus for a content search system, used in a content search system, included in a network with at least one terminal apparatus, said terminal apparatus comprising: a display controlling device for controlling a displaying device to display at least two of a plurality of basic icons, each of which represents an attribute of the content, as operation target icons on a display screen of the predetermined displaying device; an operation information generating device for generating predetermined operation information if an input is given indicating that at least two of the operation target icons are to be combined, the operation information indicating that the at least two is to be combined; and a communicating device for transmitting the operation information through the network,
said server apparatus comprising:
a first searching device for searching for a combined icon from the plurality of basic icons on the basis of a correspondence relationship set in advance if the transmitted operation information is obtained, the combined icon being defined as a combination of the at least two operation target icons to be combined; and
a second searching device for searching for the content corresponding to the searched combined icon from the plurality of contents to which at least one value for defying the attribute is given in advance.

16. A content search method for searching for predetermined types of contents on a display screen provided for a displaying device, said content search method comprising:
a display controlling process of controlling the displaying device to display at least two of a plurality of basic icons, each of which represents an attribute of the content, as operation target icons on the display screen;
a first searching process of searching for a combined icon from the plurality of basic icons on the basis of a correspondence relationship set in advance if an input is given indicating that at least two of the operation target icons are to be combined, the combined icon being defined as a combination of the at least two operation target icons to be combined; and
a second searching process of searching for the content corresponding to the searched combined icon from the plurality of contents to which at least one value for defying the attribute is given in advance.

17. A computer program product in a computer-readable medium for tangibly embodying a program of instructions executable by a computer system, said computer program making the computer system function as the content search apparatus according to claim 1.

18. A computer program product in a computer-readable medium for tangibly embodying a program of instructions executable by a computer system, said computer program making the computer system function as the terminal apparatus according to claim 14.

19. A computer program product in a computer-readable medium for tangibly embodying a program of instructions executable by a computer system, said computer program making the computer system function as the server apparatus according to claim 14.
